(19) United States
(12) Patent Application Publication
(10) Pub. No.: US 2011/0248939 A1
(43) Pub. Date: Oct. 13, 2011

(54) APPARATUS AND METHOD FOR SENSING TOUCH

(75) Inventors: Joo Kyung WOO, Yongin-si (KR); Jong Woo Jung, Hwaseong-si (KR); In Sik Myung, Incheon-si (KR)

(73) Assignee: SAMSUNG ELECTRONICS CO., LTD., Suwon-si (KR)

(21) Appl. No.: 12/964,512

(22) Filed: Dec. 9, 2010

(30) Foreign Application Priority Data
Apr. 8, 2010 (KR) 10-2010-0032256

(51) Int. Cl. G06F 3/041

(52) U.S. Cl. 345/173

(57) ABSTRACT

An apparatus and method for sensing a touch are provided. A touch type of a touch input may be determined based on a contact area of the touch input, and a function may be performed based on the touch type and a touch scheme of the touch input and it may be possible to provide a user with various interactions in a touch interface environment.

### CROSS-REFERENCE TO RELATED APPLICATION(S)

This application claims the benefit under 35 U.S.C. §119(a) of Korean Patent Application No. 10-2010-0032256, filed on Apr. 8, 2010, in the Korean Intellectual Property Office, the entire disclosure of which is incorporated herein by reference for all purposes.

### BACKGROUND

1. Field

The following description relates to an apparatus and method for sensing touch, and more particularly, to an apparatus and method for sensing touch based on a characteristic of a touch input.

2. Description of Related Art

A touch screen is an electronic visual display that can detect the presence and location of a touch within the display area. The term generally refers to touching the display of the device with a finger or hand. Touch screens can also sense other passive objects, such as a stylus. As a result of popularization of touch screens, studies are being actively performed to enable a variety of interaction schemes that are provided in an existing Personal Computer (PC) environment to be available on touch screens.

In particular, as prices of touch screens decrease, touch screens may be applied to high-priced smart phones, as well as to public displays, or kiosks. In other words, touch screens are becoming being widespread in various fields.

Additionally, touch screens provide main interaction schemes provided in the existing PC environment, for example clicking, dragging, and the like, even though a special input scheme, such as a touch input, is available on touch screens that are unavailable in an existing PC environment. An interaction method of the touch input may be provided, for example, a signal may be simply input by merely touching a touch screen, rather than using a mouse or a keyboard.

### SUMMARY

In one general aspect, there is provided a touch sensing apparatus, including: a calculating unit configured to calculate a contact area of a touch input, the touch input being performed on a touch screen, a determining unit configured to determine a touch type of the touch input based on the contact area, and a processing unit configured to perform a function, the function being associated with the touch type and a touch scheme of the touch input.

The touch sensing apparatus may further include that the function is further associated with a file type of a target file, the target file being targeted for the touch input.

The touch sensing apparatus may further include that, in response to a plurality of touch inputs being performed, the function is further associated with a number of the touch inputs.

The touch sensing apparatus may further include that the determining unit is further configured to: determine the touch input to be a first touch type in response to a value of the contact area being less than a reference value, and determine the touch input to be a second touch type in response to a value of the contact area being greater than the reference value.

The touch sensing apparatus may further include that the touch scheme includes at least one of: clicking, double-clicking, dragging, and holding.

The touch sensing apparatus may further include: an input unit configured to receive matching information between the touch scheme, the touch type, and the function, wherein the processing unit is further configured to perform the function associated with the touch scheme and the touch type, based on the matching information.

In another general aspect, there is provided a touch sensing method, including: calculating a contact area of a touch input, the touch input being performed on a touch screen, determining a touch type of the touch input based on the contact area, and performing a function, the function being associated with the touch type and a touch scheme of the touch input.

The touch sensing method may further include that the function is further associated with a file type of a target file, the target file being targeted for the touch input.

The touch sensing method may further include that, in response to a plurality of touch inputs being performed, the function is further associated with a number of the touch inputs.

In another general aspect, there is provided a touch sensing method, including: determining a touch type, determining a touch scheme, determining a file type, determining a number of touch inputs, and performing a function, the function being associated with the touch type, the touch scheme, the file type, and the number of touch inputs.

The touch sensing method may further include that the touch type includes one of: Point Touch, Plane Touch, Point+Point, Point+Plane, and Plane+Plane.

The touch sensing method may further include that the touch scheme includes one of: Click, Drag, Drag in opposite direction, and Hold+Drag.

The touch sensing method may further include that the file type includes one of: an image file, a list file, Paint, and a text box.

The touch sensing method may further include that the number of touch inputs includes one of: single-touch and multi-touch.

A non-transitory computer readable recording medium may store a program to cause a computer to implement any of the above methods.

In another general aspect, there is provided a touch sensing apparatus, including: a determining unit configured to determine: a touch type, a touch scheme, a file type, and a number of touch inputs, and a processing unit configured to perform a function, the function being associated with the touch type, the touch scheme, the file type, and the number of touch inputs.

Other features and aspects may be apparent from the following detailed description, the drawings, and the claims.

### BRIEF DESCRIPTION OF THE DRAWINGS

FIG. 1 is a diagram illustrating an applicable example of a touch operating system according to an embodiment.

FIG. 2 is a diagram illustrating a touch sensing apparatus according to an embodiment.

FIG. 3 is a table illustrating functions associated with combinations of a number of touch inputs, a touch type, a touch scheme, and a file type according to an embodiment.

FIG. 4 is a flowchart illustrating a touch sensing method according to an embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses, and/or methods described herein will be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, description of well-known functions and constructions may be omitted for increased clarity and conciseness.

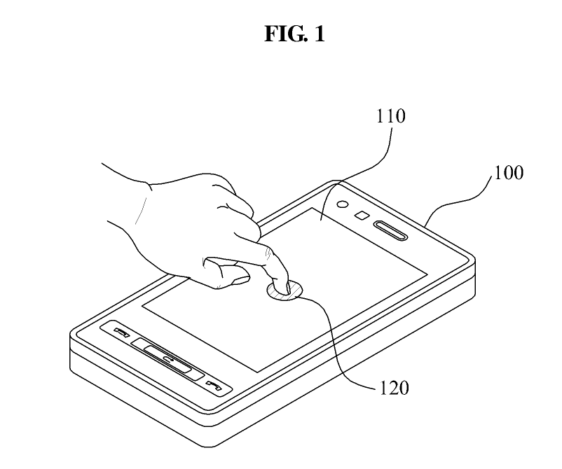

FIG. 1 illustrates an applicable example of a touch operating system.

Referring to FIG. 1, a user may input an input signal to a terminal 100 by touching a touch screen 110 of the terminal 100. In other words, the user may perform a touch input on the touch screen 110.

Depending on embodiments, a user may perform a touch input to input an input signal, using a part of his or her body, e.g., a hand, a finger, and the like, or using a tool, e.g., a touch pen, a stylus, and the like.

For example, a touch sensing apparatus according to an embodiment may calculate an area of the touch screen 110 touched by the user. For example, the touch sensing apparatus may calculate a contact area 120 of the touch input performed on the touch screen 110.

The touch sensing apparatus may determine a touch type of the touch input based on the contact area 120. Depending on embodiments, the touch sensing apparatus may determine the touch type of the touch input, based on, for example, a predetermined factor indicating a size of the contact area 120. The predetermined factor may include, e.g., a diameter of the contact area 120, a number of touched pixels, a pressure, a pressure per area, and the like. A depth of contact may also be determined, for example, by determining a stretching of a surface of the touch screen 110, e.g., by capacitance.

For example, in response to a diameter of the contact area 120 being less than a reference value, e.g., 1 centimeter (cm), the touch sensing apparatus may determine the touch type to be a point touch. Additionally, in response to the diameter of the contact area 120 being greater than the reference value, the touch sensing apparatus may determine the touch type to be a plane touch.

The touch sensing apparatus may perform a function associated with the determined touch type and a touch scheme of the touch input. For example, in response to the touch scheme being determined to be dragging, and in response to the touch type being determined to be a point touch, the touch sensing apparatus may unlock the terminal 100. Additionally, in response to the touch scheme being determined to be double-clicking, and in response to the touch type being determined to be a plane touch, the touch sensing apparatus may power off the terminal 100.

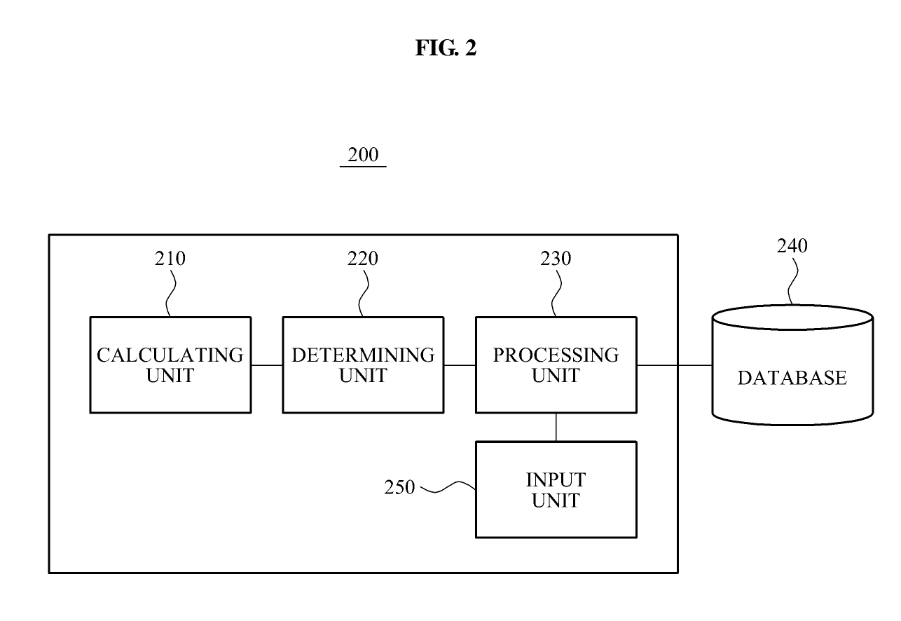

FIG. 2 illustrates a touch sensing apparatus 200 according to an embodiment.

Referring to FIG. 2, the touch sensing apparatus 200 may include a calculating unit 210, a determining unit 220, and a processing unit 230.

The calculating unit 210 may calculate a contact area of a touch input that is performed on a touch screen. Depending on embodiments, the calculating unit 210 may calculate the contact area based on a ratio of a number of touched pixels to a total number of pixels of the touch screen.

The determining unit 220 may determine a touch type of the touch input based on the contact area. The “touch type” refers to a type of the touch input. In one example, the touch type may include a point touch and a plane touch.

Depending on embodiments, in response to a value of the contact area of the touch input being less than a predetermined reference value, the determining unit 220 may determine the touch type to be a first touch type, for example a point touch. Additionally, in response to the value of the contact area being greater than the predetermined reference value, the determining unit 220 may determine the touch type to be a second touch type, for example a plane touch.

The touch sensing apparatus 200 may further include an input unit 250. The input unit 250 may receive an input of a reference value used to determine the touch type. For example, the input unit 250 may receive a “diameter of 0.5 cm” input by a user as a reference value of the contact area.

The processing unit 230 may perform a function that is associated with a touch type and a touch scheme of the touch input 250. For example, the function may be associated with a combination of the touch type and the touch scheme.

The “touch scheme” refers to a scheme by which a user touches the touch screen. The touch scheme may include at least one of clicking, double-clicking, dragging, and holding.

Depending on embodiments, the touch input may include a plurality of touch schemes, and a plurality of touch types. Accordingly, a plurality of combinations may be provided using the plurality of touch schemes and the plurality of touch types as parameters. For example, functions executable in a program or an application may be allocated for each of the plurality of combinations.

For example, the touch input may include a touch scheme, such as clicking and double-clicking, and a touch type, such as a point touch and a plane touch. In one example, four combinations may be provided based on the clicking, double-clicking, point touch, and plane touch as parameters. Example combinations may include, for example, clicking and point touch, clicking and plane touch, double-clicking and point touch, and double-clicking and plane touch. Additionally, functions executable in a program or an application may be allocated for each of the combinations. For example, in response to the touch input being performed by a combination of clicking and point touch, the processing unit 230 may display attributes of a program. In addition, in response to the touch input being performed by a combination of double-clicking and point touch, the processing unit 230 may run a program.

The processing unit 230 may also perform a function that corresponds to a file type of a target file being targeted for the touch input, the touch scheme, and the touch type.

The target file may be a target program or a target application that is to be targeted for touch input. In the embodiment, the target file may include at least one of a document file, an image file, an audio file, a moving image file, and a program execution file.

According to an aspect, in response to different target files being touched even in response to using the same touch scheme and the same touch type, different functions may be performed. For example, in response to a user's touching a document file by a combination of clicking and point touch, the processing unit 230 may open the document file. Additionally, in response to a user's touching an image file by the combination of clicking and point touch, the processing unit 230 may enlarge a scale of the image file.

In one example, in response to a plurality of touch inputs being performed on the touch screen, the processing unit 230 may perform a function that is associated with a number of the touch inputs, the touch scheme, and the touch type. Depending on embodiments, the touch input may be classified into a single-touch and a multi-touch. The “single-touch” refers to an example in which only a single touch input is performed, and the “multi-touch” refers to an example in which a plurality of touch inputs are performed.

As discussed above, the touch sensing unit 200 may further include an input unit 250. The input unit 250 may receive an input of matching information between a touch scheme, a touch type, and a function. For example, the input unit 250 may receive, from a user, information regarding a function associated with a combination of the touch scheme and the touch type.

Additionally, the input unit 250 may receive an input of matching information between a number of touch inputs, a touch type, a touch scheme, a file type of a target file, and a function. For example, the input unit 250 may receive, from the user, information regarding a function associated with a combination of the number of touch inputs, the touch type, the touch scheme, and the file type of the target file.

The processing unit 230 may perform the function associated with the touch scheme and the touch type, based on the matching information received through the input unit 250.

For example, in response to a “file copy” function being set in advance as a function associated with a combination of dragging and point touch, and in response to a user's desiring to change the “file copy” function being associated with the combination of dragging and point touch to a “file deletion” function, the user may input matching information regarding dragging, point touch, and file deletion to the input unit 250. In response to the touch input being performed by dragging and point touch, the processing unit 230 may perform the file deletion function based on the matching information received through the input unit 250.

In an example embodiment, a user may store, in a database 240, information regarding a function associated with a combination of the number of touch inputs, the touch type, the touch scheme, and the file type of the target file. The touch sensing apparatus 200 may receive the stored information from the database 240, and the processing unit 230 may perform a function associated with the touch input based on the information received from the database 240.

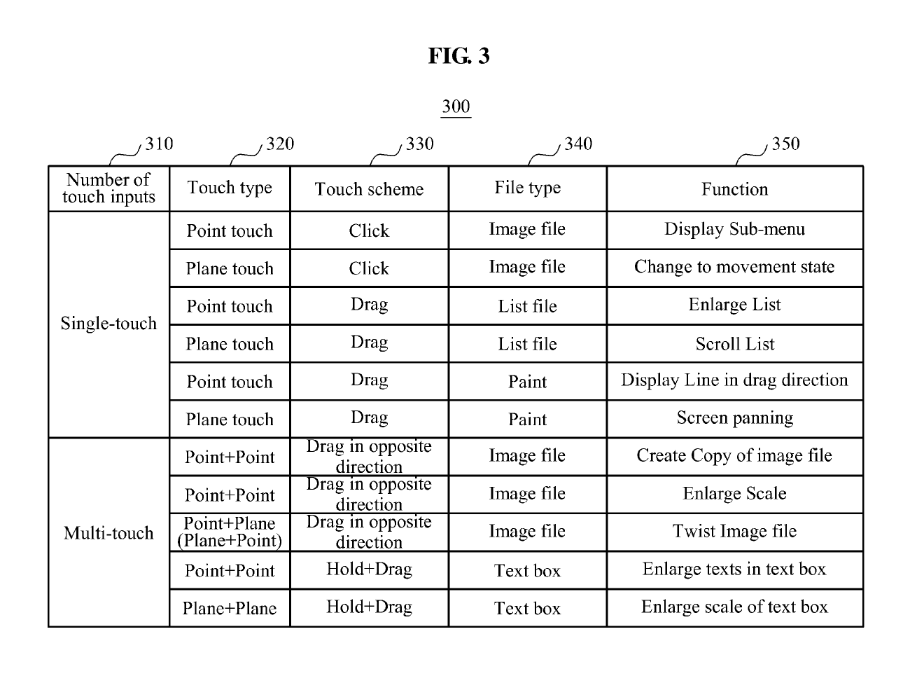

An embodiment of functions being associated with combinations of a number of touch inputs, a touch type, a touch scheme, and a file type will be described with reference to FIG. 3.

FIG. 3 illustrates a table 300 which shows functions associated with combinations of the number of touch inputs, the touch type, the touch scheme, and the file type.

Referring to FIG. 3, the table 300 may include a number-of-touch inputs field 310, a touch type field 320, a touch scheme field 330, a file type field 340, and a function field 350.

Functions shown in the table 300 may be performed by the touch sensing apparatus according to the embodiment, in response to the touch input. However, the table 300 is merely an example and, accordingly, embodiments are not limited to the table 300.

As an example, as shown in the table 300, in response to the number-of-touch inputs field 310, the touch scheme field 330 and the file type field 340 may respectively indicating “Single-touch,” “Click,” and “Image file,” and in response to the touch type field 320 indicating “Point touch,” the touch sensing apparatus according to the embodiment may display a sub-menu of the image file, as shown in the function field 350. In one example, in response to the touch type field 320 indicating “Plane touch,” the touch sensing apparatus may change a state of the image file to a movement state as shown in the function field 350.

Additionally, in response to the number-of-touch inputs field 310, the touch scheme field 330, and the file type field 340 respectively indicating “Single-touch,” “Drag,” and “List file,” and in response to the touch type field 320 indicating “Point touch,” the touch sensing apparatus may enlarge a list in the list file, as shown in the function field 350. In one example, in response to the touch type field 320 indicating “Plane touch,” the touch sensing apparatus may scroll the list in the list file as shown in the function field 350.

Furthermore, in response to the number-of-touch inputs field 310, the touch scheme field 330, and the file type field 340 respectively indicating “Single-touch,” “Drag,” and “Paint,” and in response to the touch type field 320 indicating “Point touch,” the touch sensing apparatus may display a line in Paint in a drag direction, as shown in the function field 350. In this example, in response to the touch type field 320 indicating “Plane touch,” the touch sensing apparatus may perform panning of a screen of Paint as shown in the function field 350. For example, Paint corresponds to Microsoft Paint. All trademarks are the property of their respective owners.

Moreover, in response to the number-of-touch inputs field 310, the touch scheme field 330, and the file type field 340 respectively indicating “Multi-touch,” “Drag in opposite direction,” and “Image file,” and in response to the touch type field 320 indicating “Point+Point,” the touch sensing apparatus may create a copy of the image file, as shown in the function field 350. For example, two touch inputs may be performed by dragging the image file in the opposite direction, so that the touch sensing apparatus may move the original image file to an area to which a first touch input between the two touch inputs is dragged, and may move the created copy of the image file to an area to which a second touch input is dragged. In one example, in response to the touch type field 320 indicating “Plane+Plane,” the touch sensing apparatus may enlarge a scale of the image file, as shown in the function field 350. Additionally, in response to the touch type field 320 indicating “Point+Plane” or “Plane+Point,” the touch sensing apparatus may twist the image file, as shown in the function field 350.

In addition, in response to the number-of-touch inputs field 310, the touch scheme field 330, and the file type field 340 respectively indicating “Multi-touch,” “Hold+Drag,” and “Text box,” and in response to the touch type field 320 indicating “Point+Point,” the touch sensing apparatus may enlarge text in the text box, as shown in the function field 350. For example, two touch inputs may be performed by holding and dragging the text box. In one example, in response to the touch type field 320 indicating “Plane+Plane,” the touch sensing apparatus may enlarge a scale of the text box, as shown in the function field 350.

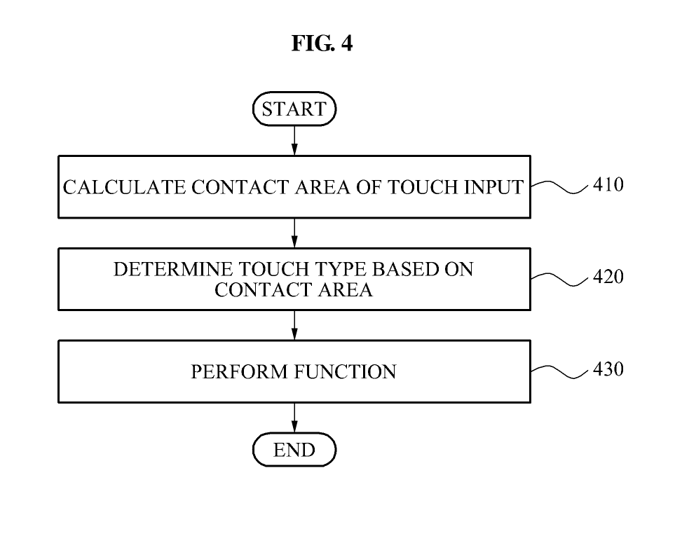

FIG. 4 illustrates a touch sensing method according to an embodiment.

Referring to FIG. 4, in operation 410, a contact area of a touch input may be calculated. For example, the touch input may be performed on a touch screen.

Depending on embodiments, the contact area may be calculated, for example, based on a ratio of a number of touched pixels to a total number of pixels of the touch screen.

In operation 420, a touch type of the touch input may be determined based on the contact area. The “touch type” refers to a type of the touch input. In one embodiment, the touch type may include a point touch and a plane touch.

Depending on embodiments, in response to a value of the contact area of the touch input being less than a predetermined reference value, the touch type may be determined to be a first touch type, for example a point touch. Additionally, in response to the value of the contact area being greater than the predetermined reference value, the touch type may be determined to be a second touch type, for example a plane touch.

The touch sensing method may further include receiving an input of a reference value used to determine the touch type. For example, a “diameter of 0.5 cm” input by a user as a reference value of the contact area may be received.

In operation 430, a function that is associated with the touch type and a touch scheme of the touch input may be performed. For example, the function may be associated with a combination of the touch type and the touch scheme. The “touch scheme” refers to a scheme by which a user touches the touch screen. The touch scheme may include at least one of clicking, double-clicking, dragging, and holding.

Depending on embodiments, the touch input may include a plurality of touch schemes, and a plurality of touch types. Accordingly, a plurality of combinations may be provided using the plurality of touch schemes and the plurality of touch types as parameters. For example, functions executable in a program or an application may be allocated for each of the plurality of combinations.

For example, the touch input may be implemented by a touch scheme, such as clicking and double-clicking, and a touch type, such as a point touch and a plane touch. In one example, four combinations may be provided based on the clicking, double-clicking, point touch, and plane touch as parameters, and may include, for example, clicking and point touch, clicking and plane touch, double-clicking and point touch, and double-clicking and plane touch. Additionally, functions executable in a program or an application may be allocated for each of the combinations. For example, in response to the touch input being performed by a combination of clicking and point touch, attributes of a program may be displayed. Additionally, in response to the touch input being performed by a combination of double-clicking and point touch, a program may be played back.

Additionally, a function that is associated with a file type of a target file being targeted for the touch input, the touch scheme, and the touch type may be performed. The target file may be a target program or a target application that is to be targeted for touch input. In the embodiment, the target file may include at least one of a document file, an image file, an audio file, a moving image file, and a program execution file.

According to an aspect, in response to different target files being touched even though using the same touch scheme and the same touch type, different functions may be performed. For example, in response to a user's touching a document file by a combination of clicking and point touch, the document file may be opened. Additionally, in response to a user's touching an image file by the combination of clicking and point touch, a scale of the image file may be enlarged.

In one embodiment, in response to a plurality of touch inputs being performed on the touch screen, a function that is associated with a number of the touch inputs, the touch scheme, and the touch type may be performed. Depending on embodiments, the touch input may be classified into a single-touch, and a multi-touch. The “single-touch” refers to an example in which only a single touch input is performed, and the “multi-touch” refers to an example in which a plurality of touch inputs are performed.

Additionally, the touch sensing method may further include receiving an input of matching information between a touch scheme, a touch type, and a function. For example, the receiving may include receiving, from a user, information regarding a function being associated with a combination of the touch scheme and the touch type.

Furthermore, the touch sensing method may further include receiving an input of matching information between a number of touch inputs, a touch type, a touch scheme, a file type of a target file, and a function. For example, the receiving may include receiving, from the user, information regarding a function associated with a combination of the number of touch inputs, the touch type, the touch scheme, and the file type of the target file.

For example, the function associated with the touch scheme and the touch type may be performed, based on the received matching information.

For example, in response to a “file copy” function being set in advance as a function being associated with a combination of dragging and point touch, and in response to a user's desiring to change the “file copy” function being associated with the combination of dragging and point touch to a “file deletion” function, he or she may input matching information regarding dragging, point touch, and file deletion to the input unit 250. In response to the touch input being performed by dragging and point touch, the file deletion function may be performed based on the received matching information.

In another embodiment, a user may store, in a database, information regarding a function associated with a combination of the number of touch inputs, the touch type, the touch scheme, and the file type of the target file. For example, according to the touch sensing method, the stored information may be received from the database, and a function being associated with the touch input may be performed based on the information received from the database.

The above-described embodiments may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions recorded on the media may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A touch sensing apparatus, comprising:
a calculating unit configured to calculate a contact area of a touch input, the touch input being performed on a touch screen;
a determining unit configured to determine a touch type of the touch input based on the contact area; and
a processing unit configured to perform a function, the function being associated with the touch type and a touch scheme of the touch input.

2. The touch sensing apparatus of claim 1, wherein the function is further associated with a file type of a target file, the target file being targeted for the touch input.

3. The touch sensing apparatus of claim 1, wherein, in response to a plurality of touch inputs being performed, the function is further associated with a number of the touch inputs.

4. The touch sensing apparatus of claim 1, wherein the determining unit is further configured to:
determine the touch input to be a first touch type in response to a value of the contact area being less than a reference value; and
determine the touch input to be a second touch type in response to a value of the contact area being greater than the reference value.

5. The touch sensing apparatus of claim 1, wherein the touch scheme comprises at least one of: clicking, double-clicking, dragging, and holding.

6. The touch sensing apparatus of claim 1, further comprising:
an input unit configured to receive matching information between the touch scheme, the touch type, and the function,
wherein the processing unit is further configured to perform the function associated with the touch scheme and the touch type, based on the matching information.

7. A touch sensing method, comprising:
calculating a contact area of a touch input, the touch input being performed on a touch screen;
determining a touch type of the touch input based on the contact area; and
performing a function, the function being associated with the touch type and a touch scheme of the touch input.

8. The touch sensing method of claim 7, wherein the function is further associated with a file type of a target file, the target file being targeted for the touch input.

9. The touch sensing method of claim 7, wherein, in response to a plurality of touch inputs being performed, the function is further associated with a number of the touch inputs.

10. A non-transitory computer readable recording medium storing a program to cause a computer to implement the method of claim 7.

11. A touch sensing method, comprising:
determining a touch type;
determining a touch scheme;
determining a file type;
determining a number of touch inputs; and
performing a function, the function being associated with the touch type, the touch scheme, the file type, and the number of touch inputs.

12. The touch sensing method of claim 11, wherein the touch type comprises one of: Point Touch, Plane Touch, Point+Point, Point+Plane, and Plane+Plane.

13. The touch sensing method of claim 11, wherein the touch scheme comprises one of: Click, Drag, Drag in opposite direction, and Hold+Drag.

14. The touch sensing method of claim 11, wherein the file type comprises one of: an image file, a list file, Paint, and a text box.

15. The touch sensing method of claim 11, wherein the number of touch inputs comprises one of: single-touch and multi-touch.

16. A non-transitory computer readable recording medium storing a program to cause a computer to implement the method of claim 11.

17. A touch sensing apparatus, comprising:
a determining unit configured to determine:
a touch type;
a touch scheme;
a file type; and
a number of touch inputs; and
a processing unit configured to perform a function, the function being associated with the touch type, the touch scheme, the file type, and the number of touch inputs.
